(19) United States
(12) Patent Application Publication
(10) Pub. No.: US 2024/0222642 A1
(43) Pub. Date: Jul. 4, 2024

(54) POSITIVE ELECTRODE CURRENT COLLECTOR FOR RECHARGEABLE LITHIUM BATTERY, POSITIVE ELECTRODE, AND RECHARGEABLE LITHIUM BATTERY INCLUDING SAME

(71) Applicant: SAMSUNG SDI CO., LTD., Yongin-si (KR)

(72) Inventors: Youngsan KO, Yongin-si (KR); Songyul OH, Yongin-si (KR); Kyuhwan CHOI, Yongin-si (KR); Junsik LEE, Yongin-si (KR); Jaehyuk KIM, Yongin-si (KR)

(21) Appl. No.: 18/451,613

(22) Filed: Aug. 17, 2023

(30) Foreign Application Priority Data
Dec. 26, 2022 (KR) 10-2022-0184918

(51) Int. Cl. H01M 4/66; H01M 4/525; H01M 4/62; H01M 10/052

(52) U.S. Cl. CPC H01M 4/663; H01M 4/525; H01M 4/622; H01M 4/624; H01M 4/667; H01M 4/668; H01M 10/052; H01M 2004/028

(57) ABSTRACT

A positive electrode current collector for a rechargeable lithium battery, a positive electrode including the same, and a rechargeable lithium battery are provided. The current collector for a positive electrode of a rechargeable lithium battery includes a substrate and a primer layer on the substrate, wherein the primer layer includes carbon nanotubes having a length of about 30 to about 200 μm, and a thickness of the primer layer is less than or equal to about 1 μm and greater than 0 μm.

### CROSS-REFERENCE TO RELATED APPLICATION

This application claims priority to and the benefit of Korean Patent Application No. 10-2022-0184918 filed in the Korean Intellectual Property Office on Dec. 26, 2022, the entire content of which is hereby incorporated by reference.

### BACKGROUND

### 1. Field

Embodiments of the present disclosure are related to a positive electrode current collector for a rechargeable lithium battery, a positive electrode, and a rechargeable lithium battery including the same.

### 2. Description of the Related Art

Recently, rechargeable batteries have been drawing a lot of attention as an energy source. For example, a rechargeable lithium battery with high energy density and discharge voltage have already been commercialized and widely utilized, but efforts to improve their performance are continuously desired and/or being made.

A positive electrode for the rechargeable lithium battery may include a current collector and a positive electrode active material layer formed on the current collector, wherein a conductive material is added to the positive electrode active material layer in order to apply conductivity to the positive electrode. However, when the conductive material is added to the positive electrode active material layer, the more conductive material added, the less positive electrode active material is utilized in proportion, thus conductivity and density are in a trade-off relationship.

### SUMMARY

One or more embodiments of the present disclosure are directed toward a positive electrode current collector for a rechargeable lithium battery capable of increasing a density of a positive electrode, lowering resistance, and improving mechanical properties; a positive electrode including the same; and a rechargeable lithium battery.

One or more embodiments will be set forth in part in the description which follows and, in part, will be apparent from the description, or may be learned by practice of the presented embodiments of the disclosure.

In one or more embodiments of the present disclosure, a primer layer including carbon nanotubes is introduced between the current collector and the positive electrode active material layer, but a length of the carbon nanotubes and a thickness of the primer layer are each limited to a specific range.

One or more embodiments of the present disclosure provide a positive electrode and a rechargeable lithium battery including the positive electrode current collector.

The positive electrode current collector for a rechargeable lithium battery according to one or more embodiments can increase a density of the positive electrode, lower resistance, and improve mechanical properties, thereby contributing to improving electrochemical characteristics of the rechargeable lithium battery.

### BRIEF DESCRIPTION OF THE DRAWINGS

FIG. 1 is a schematic view showing a portion of a positive electrode current collector according to one or more embodiments of the present disclosure.

FIG. 2 is a schematic view showing a portion of an anode according to one or more embodiments of the present disclosure.

FIG. 3 is an exploded perspective view of a rechargeable lithium battery according to one or more embodiments of the present disclosure.

FIG. 4 is an SEM image of a cut surface of the positive electrode of Comparative Example 2, and FIG. 5 is a 1.5-fold magnified view of a portion of FIG. 4.

FIG. 6 is a SEM image of a cut surface of the anode of Example 2, and FIG. 7 is a 1.5-fold magnified view of a portion of FIG. 6.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

The embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise.

The term “combination thereof” means a mixture, laminate, composite, copolymer, alloy, blend, reaction product, and/or the like of the constituents.

It should be understood that terms such as “comprises,” “includes,” or “have” are intended to specify the presence of the stated feature, number, step, element, or a combination thereof, but it does not preclude the possibility of the presence or addition of one or more other features, number, step, element, or a combination thereof.

As used herein, the term “and/or” includes any and all combinations of one or more of the associated listed items. Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

In the drawings, the thickness of layers, films, panels, regions, etc., may be exaggerated for clarity and like reference numerals designate like elements throughout, and duplicative descriptions thereof may not be provided.

It will be understood that when an element such as a layer, film, region, or substrate is referred to as being “on” another element, it can be directly on the other element or one or more intervening elements may also be present. In contrast, when an element is referred to as being “directly on” another element, there are no intervening elements present. In addition, it will also be understood that when an element or layer is referred to as being “between” two elements or layers, it can be the only element or layer between the two elements or layers, or one or more intervening elements or layers may also be present.

In the present disclosure, when particles are spherical, “diameter” indicates a particle diameter or an average particle diameter, and when the particles are non-spherical, the “diameter” indicates a major axis length or an average major axis length.

The diameter (or size) of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

In addition, “layer” herein includes not only a shape formed on the whole surface when viewed from a plan view, but also a shape formed on a partial surface.

“Length” means a straight-line distance in a direction where the distance from one end to the other is relatively long. Also, depending on context, the length may refer to an average length (or size), e.g., the average length (or size) of nanotubes whose cumulative volume corresponds to 50 vol % in the nanotube length (or size distribution (e.g., cumulative distribution), and refers to the value of the nanotube length (or size) corresponding to 50% from the smallest nanotube when the total number of nanotubes is 100% in the distribution curve accumulated in the order of the smallest nanotube length (or size) to the largest nanotube length (or size).

“Thickness” may be measured through a thickness measurer or a image taken with an optical microscope such as a scanning electron microscope.

“Weight average molecular weight (Mw)” may be a value in terms of polystyrene, as measured by gel permeation chromatography (GPC).

“Viscosity-average Molecular Weight (Mv)” is measured by dissolving the polymer pellet in methylene chloride and measuring an intrinsic viscosity [r] of the obtained filtrate at 20° C. utilizing an Uberode-type or kind viscous tube and is calculated using Schnell's Equation.

$$[ η ] = 1.23 \times {10}^{∧} ( - 5 ) \times {Mv}^{∧} ( 0.83 )$$

### Positive Electrode Current Collector for Rechargeable Lithium Battery

In one or more embodiments, a positive electrode current collector for a rechargeable lithium battery includes a substrate and a primer layer on the substrate, wherein the primer layer includes carbon nanotubes having a length (e.g., an average length or each having a length) of about 30 to about 200 μm, and a thickness of the primer layer is less than or equal to about 1 μm (however, greater than 0 μm).

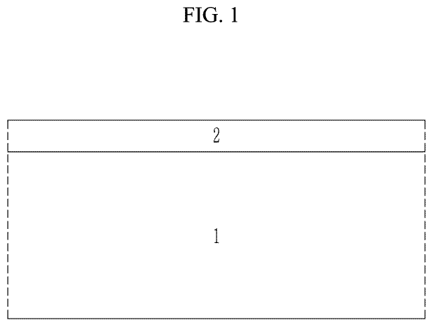

FIG. 1 is a schematic view showing a portion of a positive electrode current collector according to one or more embodiments of the present disclosure. For example, FIG. 1 shows the positive electrode current collector for a rechargeable lithium battery according to one or more embodiments viewed in the thickness direction, only between both ends marked by a dotted line. For reference the primer layer has a thickness corresponding to about 3% or less of a total thickness of a positive electrode including the positive electrode current collector for a rechargeable lithium battery according to one or more embodiments. However, in FIG. 1, the primer layer is illustrated to be thicker than the ratio in order to emphasize the presence of the primer layer.

In the positive electrode current collector for a rechargeable lithium battery, a primer layer 2 is disposed on at least one surface of a substrate 1, and components constituting the primer layer 2 have conductivity. Accordingly, the primer layer separately having conductivity from the positive electrode active material layer is introduced into the positive electrode including the positive electrode current collector of one or more embodiments, not affecting an amount of the positive electrode active material but reducing resistance in the positive electrode active material layer.

Furthermore, the positive electrode current collector for a rechargeable lithium battery according to one or more embodiments uses carbon nanotubes having a length (e.g., an average length or each having a length) of about 30 μm to about 200 μm. When carbon nanotubes having a length of less than μm 30 μm are utilized, mechanical properties (tensile strength, elongation, etc.) are increased in addition to resistance being much more significantly reduced or substantially reduced.

These effects may be achieved, even when the primer layer is formed to have a thin thickness of less than or equal to about 1 μm (however, greater than about 1 0 μm). Accordingly, when the positive electrode current collector for a rechargeable lithium battery according to one or more embodiments is utilized, including providing the primer layer to have a thin thickness of less than or equal to about 1 μm, the positive electrode active material layer formed thereon may be formed to be significantly thick, realizing a high-capacity positive electrode.

Comprehensively, the positive electrode current collector for a rechargeable lithium battery according to one or more embodiments may not only increase density of the positive electrode but also reduce the resistance and increase the mechanical properties, contributing to improving electrochemical characteristics of a rechargeable lithium battery.

Hereinafter, the positive electrode current collector for a rechargeable lithium battery according to one or more embodiments is described in more detail.

### Substrate

The substrate is a site where electrons move in the electrochemical reaction of the active material, and is generally made to have a thickness of about 3 to about 500 μm.

The substrate is not particularly limited as long as it does not cause chemical change in the battery and has high conductivity, and an aluminum foil, a nickel foil, and/or the like can be utilized. For example, aluminum foil may be utilized as in examples described later.

### Primer Layer

### Carbon Nanotubes (CNT)

The carbon nanotubes should (basically) have low resistance and high tensile strength, compared with amorphous carbon (e.g., acetylene black), wherein the longer the carbon nanotubes, the lower the resistance and the higher the mechanical properties (tensile strength, elongation, etc.).

In one or more embodiments, the carbon nanotubes have a length of about 30 μm or more, wherein the longer the carbon nanotubes, the more resistance is reduced and more mechanical properties are improved. However, when the carbon nanotubes have a length of greater than about 200 μm, there are no (or substantially no) additional effects of reducing the resistance and increasing the mechanical properties. Accordingly, the positive electrode current collector for a rechargeable lithium battery according to one or more embodiments uses carbon nanotubes with a length of greater than or equal to about 30 μm, greater than or equal to about 40 μm, or greater than or equal to about 50 μm and less than or equal to about 200 μm. In one or more embodiments, carbon nanotubes with a length of greater than or equal to about 50 μm and less than or equal to about 200 μm have significantly excellent or suitable effects.

The longer carbon nanotubes achieve the more increased mechanical properties, which may be due to an increase in crystallinity. For example, when the carbon nanotubes have a length of greater than or equal to about 30 μm, greater than or equal to about 40 μm, or greater than or equal to about 50 μm and less than or equal to about 200 μm, crystallinity (Id/Ig) thereof may be greater than or equal to about 0.45, greater than or equal to about 0.7, greater than or equal to about 0.85, greater than or equal to about 1.1, or greater than or equal to about 1.15, less than or equal to about 1.6, less than or equal to about 1.3, or less than or equal to about 1.16. Herein, the ‘crystallinity’ is Id/Ig measured with a Raman spectroscope, and in the Raman spectrum analysis, intensity (Ig) of a peak (G, about 1580 cm⁻¹) and intensity (Id) of another peak (D, about 1350 cm⁻¹) are measured to calculate a ratio (R=ld/Ig).

The carbon nanotubes may be arranged in a horizontal direction in relation to the surface of the substrate. When the carbon nanotubes are horizontally arranged with the surface of the substrate, compared with when the carbon nanotubes are vertically arranged with the surface of the substrate, even though the primer layer is formed to have a thin thickness, a positive electrode with low resistance and high mechanical properties may be realized, and accordingly, the positive electrode active material layer may be formed to be sufficiently thick to realize a high-capacity positive electrode.

### Dispersant

The primer layer may further include a dispersant. The dispersant is not particularly limited as long as it is a material that functions to uniformly disperse the carbon nanotubes on the surface of the substrate, but may include at least one of (e.g., one selected from) a hydrogenated nitrile butadiene rubber, polyvinylpyrrolidone, polyvinylidene fluoride, a styrene-butadiene rubber, an acrylated styrene-butadiene rubber, an organic compound having a basic functional group, and/or an amine-based compound.

In one or more embodiments, when the hydrogenated nitrile butadiene rubber and polyvinylpyrrolidone are mixed and utilized as the dispersant, it functions as an impact absorber as well as a dispersing function, thereby suppressing or reducing damage to the substrate during a manufacturing process of the positive electrode (for example, the active material coating process). In one or more embodiments, a stable rechargeable lithium battery can be easily implemented even in a high voltage environment.

When utilizing a mixture of the hydrogenated nitrile butadiene rubber and polyvinylpyrrolidone as the dispersant, they may be mixed in a weight ratio of about 10:90 to about 90:10, about 20:80 to about 80:20, or about 30:70 to about 70:30.

A content (e.g., amount) of the dispersant in the total amount of the primer layer may be greater than 0 wt % and less than or equal to about 50 wt % or less than or equal to about 40 wt %. In one or more embodiments, in the primer layer, a weight ratio of the carbon nanotubes to the dispersant is about 95:5 to about 50:50, about 90:10 to about 55:45, about 80:20 to about 60:40, or about 70:30 to about 60:40. The dispersant, regardless of its type or kind, can sufficiently exhibit its function when the content (e.g., amount) in the total amount of the primer layer and the weight ratio with the carbon nanotubes satisfy the above ranges.

### Primer Layer

The primer layer may have a thickness of less than or equal to about 1 μm (however, greater than 0 μm). In this way, even though the primer layer is formed to have a thin thickness, a positive electrode with low resistance and high strength may be realized, and accordingly, the positive electrode active material layer may be formed to be sufficiently thick, realizing a high-capacity positive electrode.

In contrast, even though the primer layer includes no other materials (e.g., binder) in addition to the dispersant, the carbon nanotubes may be well attached to the current collector.

### Positive Electrode for Rechargeable Lithium Battery

One or more embodiments provide a positive electrode for a rechargeable lithium battery including the positive electrode current collector of the aforementioned embodiment(s) and further including a positive electrode active material layer on the primer layer.

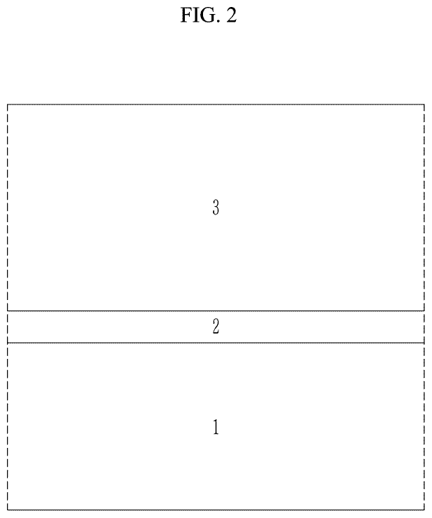

FIG. 2 is a schematic view showing a portion of a positive electrode according to one or more embodiments of the present disclosure. For example, FIG. 2 shows the positive electrode of one or more embodiments viewed in the thickness direction, only between both ends thereof marked by a dotted line. For reference, the primer layer may have a thin thickness corresponding to less than or equal to about 3% of a total thickness of the positive electrode of one or more embodiments. However, in FIG. 2, in order to emphasize the presence of the primer layer, the primer layer is illustrated thicker than the ratio.

In the positive electrode current collector for a rechargeable lithium battery according to one or more embodiments, a primer layer 2 and a positive electrode active material layer 3 are sequentially disposed on at least one surface of a substrate 1.

Hereinafter, the positive electrode for a rechargeable lithium battery is described in more detail.

### Current Collector

The positive electrode of one or more embodiments uses the positive electrode current collector of the aforementioned embodiment(s).

### Primer Layer

As mentioned above, the primer layer may have a thickness of less than or equal to about 1 μm (however, greater than 0 μm). When considering the total thickness of the positive electrode as 100%, the thickness of the primer layer may occupy less than or equal to about 3% (however, greater than 0%).

In this way, even though the primer layer is formed to have a thin thickness, a positive electrode with low resistance and high strength may be realized, and accordingly, the positive electrode active material layer to be sufficiently thick, realizing a high-capacity positive electrode.

In one or more embodiments, description of the positive electrode current collector is the same as above.

### Positive Electrode Active Material Layer

The positive electrode active material layer includes a positive electrode active material, and may optionally further include a conductive material, a binder, and/or the like.

### Positive Electrode Active Material

The positive electrode active material may include lithiated intercalation compounds that reversibly intercalate and deintercalate lithium ions. Examples of the cathode active material include a compound represented by any one of the following chemical formulas: LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0 c≤0.05); LiₐNi_{1-b-c}CO_{b}X_{c}Dₐ (0.90≤a≤1.8, 0 b≤0.5, 0≤c≤0.5, 0≤a≤2); LiaNi_{1-b-c}C_{b}X_{c}O₂₋ₐTₐ (0.90≤a 1.8, 0≤b≤0.5, 0<5 c<0.05, 0<a<2); LiₐNi_{1-b-c}CO_{b}X_{c}O₂₋ₐT₂ (0.90≤a≤1.8, 0≤b≤0.5, 0≤c≤0.05, 0<a<2); LiₐNi_{1-b-c}Mn_{b}X_{c}Dₐ (0.90≤a≤1.8, 0≤b≤0.5, 0≤c≤s 0.05, 0≤a≤2); LiₐNi_{1-b-c}Mn_{b}X_{c}O₂₋ₐTₐ (0.90≤a≤1.8, 0≤b≤0.5, 0≤c≤0.05, 0<a<2); LiₐNi_{1-b-c} Mn_{b}X_{c}O₂₋ₐT₂ (0.90≤a≤1.8, 0≤b≤0.5, 0≤c≤0.05, 0<a<2); LiₐNi_{b}E_{c}G_{d}O₂ (0.90≤a≤1.8, 0≤b≤0.9, 0≤c≤0.5, 0.001<d≤0.1); LiₐNi_{b}Co_{c}Mn_{d}G_{b}O₂ (0.90≤a≤1.8, 0≤5 b≤0.9,0≤c≤0.5, 0≤d≤0.5, 0.001≤e≤0.1); LiₐNiG_{b}O₂(0.90≤a≤1.8, 0.001≤b<0.1); LiₐCoG_{b}O₂ (0.90≤a≤1.8, 0.001≤b≤0.1); LiₐMn_{1-b}GbO₂ (0.90≤a≤1.8, 0.001<b≤0.1); LiₐMn₂GbO₄ (0.90≤a≤1.8, 0.001≤b≤0.1); LiₐMn_{1-g}G_{b}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≥f≥2); Li_{(3-f)} Fe₂(PO₄)₃ (0≤f≤2); or LiₐFePO₄(0.90≤a≤1.8).

In the above chemical formulas, A is (e.g., is selected from) Ni, Co, Mn, and/or a combination thereof; X is (e.g., is selected from) Al, Ni, Co, Mn, Cr, Fe, Mg, Sr, V, a rare earth element, and/or a combination thereof; D is (e.g., is selected from) O, F, S, P, and/or a combination thereof; E is (e.g., is selected from) Co, Mn, and/or a combination thereof; T is (e.g., is selected from) F, S, P, and/or a combination thereof; G is (e.g., is selected from) Al, Cr, Mn, Fe, Mg, La, Ce, Sr, V, and/or a combination thereof; Q is (e.g., is selected from) Ti, Mo, Mn, and/or a combination thereof; Z is (e.g., is selected from) Cr, V, Fe, Sc, Y, and/or a combination thereof; and J is (e.g., is selected from) V, Cr, Mn, Co, Ni, Cu, and/or a combination thereof.

The compounds may have a coating layer on the surface, or may be mixed with another compound having a coating layer. The coating layer may include at least one coating element compound of (e.g., selected from) an oxide of a coating element, a hydroxide of a coating element, an oxyhydroxide of a coating element, an oxycarbonate of a coating element, and/or a hydroxy carbonate of a coating element.

The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. A method of providing the coating layer may be a method that does not adversely affect physical properties of the positive electrode active material, for example, spray coating, dipping, and/or the like.

For example, the positive electrode active material may include a composite oxide of cobalt, manganese, nickel, aluminum, iron, or a combination thereof and lithium, and may include, for example, a lithium cobalt composite oxide represented by Chemical Formula 1.

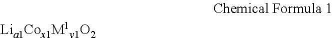

In Chemical Formula 1, 0.9a1<1.8, 0.3≤x≤1, 0≤y1≤0.7, and M¹ is (e.g., is selected from) Al, B, Ce, Co, Cr, F, Mg, Mn, Mo, Nb, P, S, Si, Sr, Ti, V, W, Zr, and/or a combination thereof.

The positive electrode active material may be, for example, LiCoO₂.

### Conductive Material

The conductive material imparts conductivity to the electrode, and examples thereof may include natural graphite, artificial graphite, carbon black, a carbon fiber, a metal powder, and/or a metal fiber, but the present disclosure is not limited thereto. These may be utilized alone or as a mixture of two or more. The metal powder and the metal fiber may utilize a metal of copper, nickel, aluminum, silver, and/or the like.

Binder

The binder improves binding properties of positive electrode active material particles with one another and with a current collector, and specific examples may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto. These may be utilized alone or as a mixture of two or more.

### Rechargeable Lithium Battery

One or more embodiments provide a rechargeable lithium battery including the positive electrode of the aforementioned embodiment(s).

Because the positive electrode of the aforementioned embodiment(s) has characteristics such as high density, low resistance, and high strength, it contributes to improving the electrochemical characteristics of the rechargeable lithium battery.

Hereinafter, the rechargeable lithium battery is described in more detail, except for overlapping descriptions with the foregoing.

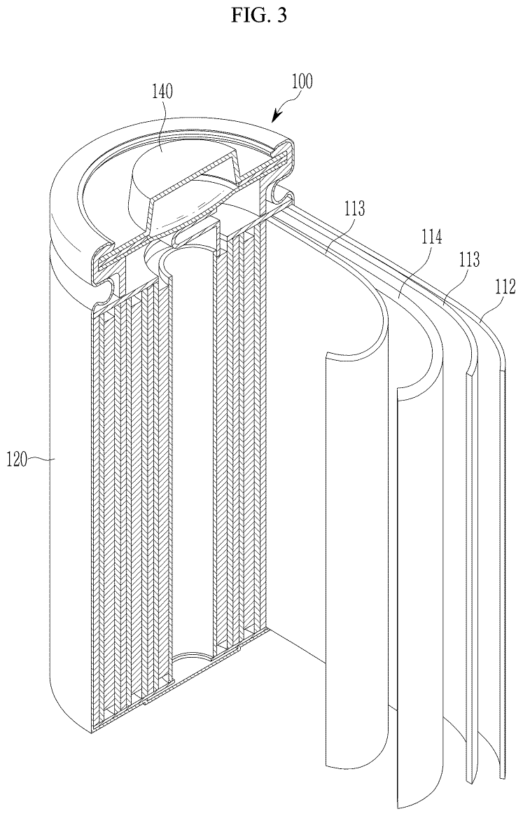

FIG. 3 is an exploded perspective view of a rechargeable lithium battery according to one or more embodiments of the present disclosure. Referring to FIG. 3, a rechargeable lithium battery 100 according to one or more embodiments includes a battery cell including a negative electrode 112, a positive electrode 114 facing the negative electrode 112, a separator 113 disposed between the negative electrode 112 and the positive electrode 114, and an electrolyte solution immersed in the negative electrode 112, positive electrode 114, and separator 113, a battery case 120 housing the battery cell, and a sealing member 140 sealing the battery case 120.

Negative Electrode

The negative electrode 112 includes a negative electrode current collector and a negative electrode active material layer formed on the negative electrode current collector.

The negative electrode current collector may utilize copper, gold, nickel, a copper alloy, and/or the like, but the present disclosure is not limited thereto.

The negative electrode active material layer may include a negative electrode active material, a binder, and optionally a conductive material. The negative electrode active material may be a material that reversibly intercalates/deintercalates lithium ions, a lithium metal, a lithium metal alloy, a material capable of doping and dedoping lithium, a transition metal oxide, or a combination thereof.

The material that reversibly intercalates/deintercalates lithium ions may be a carbon material which is any suitably and/or generally-utilized carbon-based negative electrode active material, and examples thereof may be crystalline carbon, amorphous carbon, or a combination thereof. Examples of the crystalline carbon may be graphite, such as irregular-shaped, sheet-shaped, flake, spherical shaped and/or fiber-shaped natural graphite and/or artificial graphite. Examples of the amorphous carbon may be soft carbon or hard carbon, a mesophase pitch carbonized product, fired coke, and/or the like. The lithium metal alloy may be an alloy of lithium and a metal of (e.g., a metal selected from) Na, K, Rb, Cs, Fr, Be, Mg, Ca, Sr, Si, Sb, Pb, In, Zn, Ba, Ra, Ge, Al, and/or Sn. The material capable of doping and dedoping lithium may be Si, SiOx (0<x<2), a Si—C composite, a Si—Y alloy, Sn, SnO₂, a Sn—C composite, a Sn—Y alloy, and/or the like, and at least one of these may be mixed with SiO₂. Specific examples of the element Y may be (e.g., may be selected from) Mg, Ca, Sr, Ba, Ra, Sc, Y, Ti, Zr, Hf, Rf, V, Nb, Tₐ, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and/or a combination thereof. The transition metal oxide may be vanadium oxide, lithium vanadium oxide, and/or the like.

The binder and the conductive material utilized in the negative electrode 112 may be the same as the binder and conductive material of the positive electrode 114.

The positive electrode 114 and the negative electrode 112 may be manufactured by mixing each active material composition including each active material and a binder, and optionally a conductive material in a solvent, and coating the active material composition on each current collector. Herein, the solvent may be N-methylpyrrolidone, and/or the like, but the present disclosure is not limited thereto. The electrode manufacturing method is generally available in the art, and thus is not described in more detail in the present specification.

### Electrolyte

The electrolyte includes an organic solvent and a lithium salt.

The organic solvent serves as a medium for transmitting ions taking part in the electrochemical reaction of a battery. Specific examples thereof may be (e.g., may be selected from) a carbonate-based solvent, an ester-based solvent, an ether-based solvent, a ketone-based solvent, an alcohol-based solvent, and an aprotic solvent. The carbonate-based solvent may be dimethyl carbonate, diethyl carbonate, dipropyl carbonate, methylpropyl carbonate, ethylpropyl carbonate, methylethyl carbonate, ethylene carbonate, propylene carbonate, butylene carbonate, and/or the like, and the ester-based solvent may be methyl acetate, ethyl acetate, n-propyl acetate, 1,1-dimethylethyl acetate, methylpropionate, ethylpropionate, y-butyrolactone, decanolide, valerolactone, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like, and the ketone-based solvent may be cyclohexanone, and/or the like. The alcohol-based solvent may be ethanol, isopropyl alcohol, and/or the like, and the aprotic solvent may be nitriles such as R—CN(R is a C2 to C20 linear or branched or cyclic hydrocarbon group, a double bond, an aromatic ring, or an ether bond), and/or the like, amides such as dimethyl formamide, dioxolanes such as 1,3-dioxolane, sulfolanes, and/or the like.

The organic solvent may be utilized alone or in a mixture of two or more, and when the organic solvent is utilized in a mixture of two or more, the mixture ratio may be controlled or selected in accordance with a desirable cell performance.

The lithium salt is dissolved in an organic solvent, supplies lithium ions in a battery, basically operates the rechargeable lithium battery, and improves lithium ion transportation between positive and negative electrodes therein. Examples of the lithium salt may include LiPF₆, LiBF₄, LiSbF₆, LiAsF₆, LiN(SO₃C₂F₅)₂, LiN(CF₃SO₂)₂, LiC₄F₉SO₃, LiCIO₄, LiAIO₂, LiAICl₄, LiN(CₓF₂ₓ₊₁SO₂)(C_{y}F_{2y+1}SO₂), wherein x and y are natural numbers, LiCI, Lil, LiB(C₂O₄)₂, or a combination thereof, but the present disclosure is not limited thereto.

The lithium salt may be utilized in a concentration in a range of about 0.1 M to about 2.0 M. When the lithium salt is included within the above concentration range, an electrolyte solution may have excellent or suitable performance and lithium ion mobility due to optimal or suitable conductivity and viscosity of the electrolyte solution.

Separator

The separator may be, for example polyolefin, polyester, polytetrafluoroethylene (PTFE), polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylenesulfide, polyethylenenaphthalene, a glass fiber, or a combination thereof, but the present disclosure is not limited thereto.

Examples of the polyolefin may be polyethylene, polypropylene, and/or the like, and examples of the polyester may be polyethyleneterephthalate, polybutyleneterephthalate, and/or the like.

In one or more embodiments, the separator may be a porous substrate in the form of a non-woven fabric or a woven fabric, and may have a single layer or multilayer structure. For example, the substrate may be a polyethylene single layer, a polypropylene single layer, a polyethylene/polypropylene double layer, a polypropylene/polyethylene/polypropylene triple layer, a polyethylene/polypropylene/polyethylene triple layer, and/or the like.

A thickness of the separator may be about 1 μm to about 40 μm, for example, about 1 μm to about 30 μm, about 1 μm to about 20 μm, about 5 to about 15 μm, or about 5 to about 10 μm. When the thickness of the separator is within the aforementioned ranges, a short-circuit between positive and negative electrodes may be prevented or reduced without increasing internal resistance of a battery.

Examples and comparative examples of the present disclosure are described below. The following examples are only examples of the present disclosure, but the present disclosure is not limited to the following examples.

### Example 1

(1) Preparation of Composition for Primer Layer

A composition for a primer layer was prepared by mixing 70 parts by weight of carbon nanotubes (CNT) and 30 parts by weight of a dispersant. Herein, the carbon nanotubes had a length of 30 μm and crystallinity (Id/Ig) of 0.85, which was measured through Raman spectrum analysis. In addition, as the dispersant, a mixture of hydrogenated nitrile butadiene rubber (Mv: 20 to 40 g/mol) and polyvinylpyrrolidone (Mw: 400,000 to 1300,000 g/mol) mixed in a weight ratio of 8:2 was utilized.

(2) Manufacture of Positive Electrode Current Collector

An aluminum foil (thickness: 12 μm) was utilized a≤a≤ubstrate, and the composition for a primer layer was coated thereon with a gravure roll coater and dried at room temperature, providing a 1 μm-thick primer layer. Through this, a positive electrode current collector including the aluminum foil (substrate) and the primer layer thereon was obtained.

(3) Manufacture of Positive Electrode

97 wt % of LiNi_{0.91}Co_{0.07}Al_{0.02}O₂ as a positive electrode active material, 1 wt % of a conductive material prepared by mixing carbon nanotube and nano carbon, and 2 wt % of polyvinylidene fluoride were mixed, preparing a positive electrode active material slurry. The positive electrode active material slurry was coated on the positive electrode current collector and then dried and compressed, obtaining a positive electrode including the positive electrode current collector and a positive electrode active material layer thereon.

Herein, the positive electrode active material layer had a loading amount of about 40 mg/cm². In addition, the primer layer had a thickness ratio of 1% based on 100% of a total thickness of the positive electrode.

(4) Manufacture of Rechargeable Lithium Battery Cell

A 2032 type or kind rechargeable lithium battery cell (coin half cell) was manufactured by winding the positive electrode into a circle shape with a diameter of 12 mm and then, utilizing it along with a lithium metal as a counter electrode and a polypropylene separator. Herein, an electrolyte solution was prepared by utilizing a mixed solvent of ethylenecarbonate, diethylenecarbonate, and fluoroethylenecarbonate mixed in a weight ratio of 2:6:2 and dissolving 1.3 M LiPF₆ therein.

### Examples 2 to 5

Each positive electrode current collector, positive electrode, and rechargeable lithium battery cell according to Examples 2 to 5 was manufactured in substantially the same manner as in Example 1 except that the length and crystallinity of the carbon nanotubes; the weight ratio of the carbon nanotubes and the dispersant were changed as shown in Table 1.

### Comparative Example 1

A positive electrode and a rechargeable lithium battery cell were manufactured in substantially the same manner as in Example 1 except that the aluminum foil itself was utilized as a positive electrode current collector.

### Comparative Example 2

A composition for a primer layer was prepared by mixing 90 parts by weight of acetylene black (AB) with a particle diameter (D₅₀) of 50 μm and 10 parts by weight of a dispersant. A positive electrode current collector, a positive electrode, and a rechargeable lithium battery cell were manufactured in substantially the same manner as in Example 1 except for the above.

### Comparative Example 3 to 6

Each positive electrode current collector, positive electrode, and rechargeable lithium battery cell according to Comparative Examples 3 to 6 was manufactured in substantially the same manner as in Example 1 except that the length and crystallinity of the carbon nanotubes; the weight ratio of the carbon nanotubes and the dispersant were changed as shown in Table 1.

TABLE 1

| | AB | | | Primer layer | | |
|---|---|---|---|---|---|---|
| | D50 | | | | | Thickness |
| | particle | CNT | | | | ratio (%) in |
| | diameter | Length | Crystallinity | Formulation | Thickness | positive |
| | (nm) | (μm) | (Id/Ig) | (weight ratio) | (μm) | electrode |
| Comp. | — | — | — | — | — | — |
| Ex. 1 | | | | | | |
| Comp. | 50 nm | — | — | AB:a dispersant = | 1 | 1 |
| Ex. 2 | | | | 90:10 | | |
| Comp. | — | 5 | 0.7 | CNT:a dispersant = | 1 | 1 |
| Ex. 3 | | | | 80:20 | | |
| Comp. | — | 10 | 0.72 | CNT:a dispersant = | 1 | 1 |
| Ex. 4 | | | | 80:20 | | |
| Comp. | — | 20 | 0.74 | CNT:a dispersant = | 1 | 1 |
| Ex. 5 | | | | 80:20 | | |
| Ex. 1 | — | 30 | 0.85 | CNT:a dispersant = | 1 | 1 |
| | | | | 70:30 | | |
| Ex. 2 | — | 50 | 0.98 | CNT:a dispersant = | 1 | 1 |
| | | | | 70:30 | | |
| Ex. 3 | — | 100 | 1.1 | CNT:a dispersant = | 1 | 1 |
| | | | | 70:30 | | |
| Ex. 4 | — | 200 | 1.15 | CNT:a dispersant = | 1 | 1 |
| | | | | 70:30 | | |
| Ex. 5 | — | 200 | 1.15 | CNT:a dispersant = | 1 | 1 |
| | | | | 60:40 | | |

| Comp. | — | 250 | 1.6 | Positive electrode cannot be manufactured |
|---|---|---|---|---|
| Ex. 6 | | | | |

### Evaluation Example 1: Characteristic Evaluation of Positive Electrode Current Collector

The positive electrode current collectors according to Examples 1 to 5 and Comparative Examples 1 to 6 were evaluated as follows.
(1) Tensile strength: A specimen was prepared by cutting each positive electrode current collector into a size of 10 mm*200 mm to measure tensile strength at room temperature according to ASTM D-638 by utilizing a universal test machine (UTM). Herein, the universal test machine (UTM) was set at a cross-head speed of 300 mm/min and set at a gauge length of 100 mm. Herein, the tensile strength was 10 P/W*t, P was stress (kgf) at break, W wa≤a≤pecimen width (mm), and t was a specimen thickness (mm). Table 2 shows measurements of the tensile strength.
(2) Elongation: A specimen was prepared by cutting each positive electrode current collector into a size of 10 mm*200 mm to measure elongation by utilizing UTM equipment. Herein, the elongation (%) is I-I₀/I*100, I₀ was an initial distance between jigs (JIG), and I was a distance after the cutting between the jigs (JIG). Table 2 shows measurements of the elongation.

### Evaluation Example 2: Characteristic Evaluation of Positive Electrode

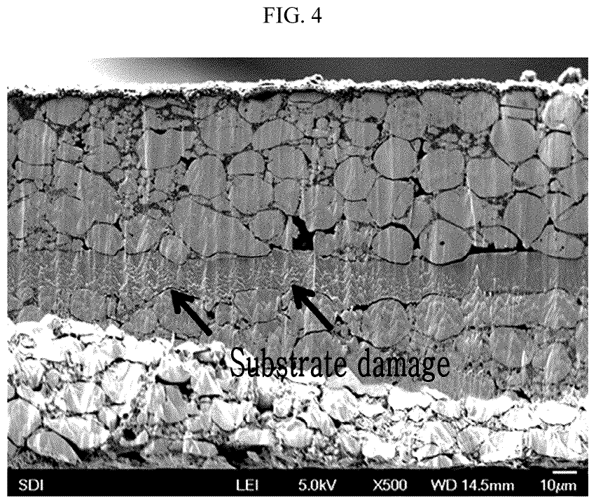

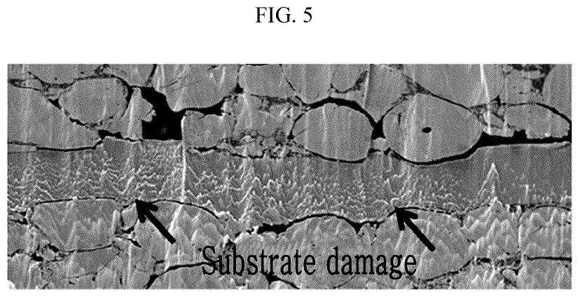

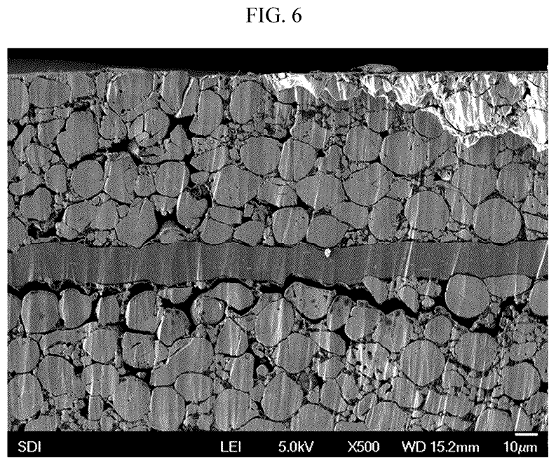

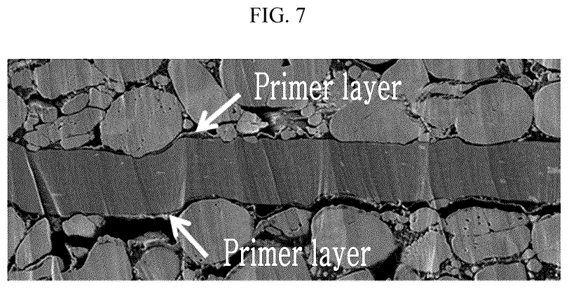

The positive electrodes of Examples 1 to 7 and Comparative Examples 1 to 6 were evaluated as follows.
(1) Resistance: The positive electrodes were respectively prepared as a circular specimen with a radius of about 1 cm and an area of about 3.14 cm² to measure resistivity in the thickness direction by utilizing a resistivity meter (CIS CO., LTD.). Table 2 shows measurements of the resistance.
(2) Positive electrode density: 3 g of positive electrode active material powder was put in a mold with an area of 1.2 cm² and packed under a pressure of 2.5 ton/cm² to measure density, and the results are shown in Table 2.
(3) SEM: The positive electrodes were respectively cut in the vertical direction with the substrate surface and then, examined with FE-SEM (Hitachi SU 8030) equipment. FIG. 4 is an SEM image of a cut surface of the positive electrode of Comparative Example 2, and FIG. 5 is a 1.5-fold magnified view of a portion of FIG. 4. FIG. 6 is an SEM image of a cross-section of the anode of Example 2, and FIG. 7 is a 1.5-fold magnified view of a portion of FIG. 6.

TABLE 2

| | Positive electrode | | Positive electrode | |
|---|---|---|---|---|
| | current collector | | | Positive |
| | Tensile | Elongation | Resistance | electrode |
| | strength (N/mm²) | (%) | (Ω · M) | density (g/cc) |
| Comp. Ex. 1 | 298.5 | 1.374 | 13.1 | 3.55 |
| Comp. Ex. 2 | 302.9 | 1.4 | 10.2 | 3.55 |
| Comp. Ex. 3 | 316.7 | 1.51 | 9.5 | 3.6 |
| Comp. Ex. 4 | 317.1 | 1.48 | 9.4 | 3.6 |
| Comp. Ex. 5 | 320.2 | 1.52 | 9.2 | 3.6 |
| Ex. 1 | 321.8 | 1.53 | 9 | 3.65 |
| Ex. 2 | 330.3 | 1.57 | 8.6 | 3.7 |
| Ex. 3 | 330.6 | 1.58 | 8.5 | 3.7 |
| Ex. 4 | 331.2 | 1.68 | 8.3 | 3.7 |
| Ex. 5 | 331.1 | 1.71 | 8.5 | 3.7 |

| | |
|---|---|
| Comp. Ex. 6 | Positive electrode cannot be manufactured |

Referring to Tables 1 and 2, the positive electrode current collectors for a rechargeable lithium battery cell according to Examples 1 to 5 exhibited excellent or suitable effects of improving mechanical properties, reducing resistance, and increasing density, compared with the positive electrode current collectors for a rechargeable lithium battery cell according to Comparative Examples 1 to 5. The positive electrode of Comparative Example 6 was impossible to manufacture. For example, the positive electrode current collectors according to Examples 1 to 5, which utilized carbon nanotubes having a length (e.g., an average length or each having a length) of about 30 to about 200 μm, turned out to increase mechanical properties (tensile strength, elongation, and/or the like) as well as significantly reduce resistance, compared with a case of utilizing carbon nanotubes with a length of less than 30 μm.

These effects were achieved, even when the primer layer was formed to be thin, that is, less than or equal to 1 μm thick (however, greater than 0 μm). Accordingly, when the positive electrode current collector for a rechargeable lithium battery cell according to one or more embodiments was utilized, including providing the primer layer to have a thin thickness of less than or equal to 1 μm thick, a positive electrode active material layer was formed thereon to be sufficiently thick, realizing a high-capacity positive electrode.

In the positive electrode current collectors according to Examples 1 to 5, the carbon nanotubes were horizontally aligned on the surface of the current collector due to the method of providing the primer layer. Herein, compared with the vertical alignment of the carbon nanotubes with the current surface, even though the primer layer was formed to be thin, a positive electrode with low resistance and high strength was realized, and accordingly, the positive electrode active material layer was formed to be sufficiently thick, realizing a high-capacity positive electrode.

Accordingly, the positive electrode current collector for a rechargeable lithium battery cell according to one or more embodiments, which were represented by Examples 1 to 5, reduced resistance and increased mechanical properties as well as increased density of the positive electrode, contributing to electrochemical characteristics of the rechargeable lithium battery cell.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Further, the use of “may” when describing embodiments of the present disclosure refers to “one or more embodiments of the present disclosure.”

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The portable device, vehicle, and/or the battery, e.g., a battery controller, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

### REFERENCE NUMERALS

1: substrate
2: primer layer
3: positive electrode active material layer
100: rechargeable lithium battery
112: negative electrode
113: separator
114: positive electrode
120: battery case
140: sealing member

What is claimed is:

1. A positive electrode current collector of a rechargeable lithium battery, the positive electrode current collector comprising:
a substrate and
a primer layer on the substrate,
wherein the primer layer comprises carbon nanotubes having an average length of about 30 to about 200 μm, and
a thickness of the primer layer is less than or equal to about 1 μm and greater than 0 μm.

2. The positive electrode current collector of claim 1, wherein the substrate is an aluminum foil.

3. The positive electrode current collector of claim 1, wherein the carbon nanotubes have a crystallinity (Id/Ig) of about 0.45 to about 1.6.

4. The positive electrode current collector of claim 1, wherein the carbon nanotubes extend in a horizontal direction in relation to a surface of the substrate.

5. The positive electrode current collector of claim 1, wherein the primer layer further comprises a dispersant.

6. The positive electrode current collector of claim 5, wherein
the dispersant comprises at least one of a hydrogenated nitrile butadiene rubber, polyvinylpyrrolidone, polyvinylidene fluoride, a styrene-butadiene rubber, an acrylated styrene-butadiene rubber, an organic compound having a basic functional group, or an amine-based compound.

7. The positive electrode current collector of claim 5, wherein an amount of the dispersant in a total amount of the primer layer is less than or equal to about 50 wt % and greater than 0 wt %.

8. The positive electrode current collector of claim 5, wherein a weight ratio of the carbon nanotubes to the dispersant is about 95:5 to about 50:50.

9. A positive electrode for a rechargeable lithium battery, the positive electrode comprising:
the positive electrode current collector of claim 1; and
a positive electrode active material layer on the primer layer.

10. The positive electrode of claim 9, wherein a thickness of the primer layer is less than or equal to about 3% and greater than 0% based on a total thickness of the positive electrode.

11. The positive electrode of claim 9, wherein
the positive electrode active material layer comprises a composite oxide of cobalt, manganese, nickel, aluminum, iron, or a combination thereof and lithium.

12. The positive electrode of claim 11, wherein the positive electrode active material layer further comprises a conductive material.

13. The positive electrode of claim 11, wherein the positive electrode active material layer further comprises a binder.

14. The positive electrode of claim 9, wherein the positive electrode active material layer has a density of greater than or equal to about 3.6 g/cc.

15. A rechargeable lithium battery, comprising:
the positive electrode of claim 9;
a negative electrode; and
an electrolyte.
